(19) United States
(12) Patent Application Publication
(10) Pub. No.: US 2012/0048280 A1
(43) Pub. Date: Mar. 1, 2012

(54) EAR LOBE SUPPORT FOR HEAVY EARRINGS WEARERS

(76) Inventors: MARILENA NOY, Coral Gables, FL (US); Victor Cuevas, Coral Gables, FL (US); Esmeralda Tarafa, Coral Gables, FL (US); Alvin Cano, Chicago, IL (US); Ray Velazquez, Coral Gables, FL (US)

(21) Appl. No.: 12/870,532

(22) Filed: Aug. 27, 2010

(51) Int. Cl. A61G 99/00

(52) U.S. Cl. 128/845

(57) ABSTRACT

A body is formed from a segment of non-corrosive wire, or rigid plastic protected by a thin layer of flexible plastic that could be colored or clear. The wire could be made of precious metal such as gold, platinum, silver, etc. or any non-corrosive metal or rigid plastic; typically this wire is from 2 to 4 inches in length with a clear elongated tong extending from the wire to conform to the shape of the wearer's earlobe. This tong could or could not present pre-made perforations for the wearer to hook the heavy earrings (not included) thus, this device will carry the weight of the earring whereof usually the weight would be in the earlobe therefore preventing and protecting the earlobe from expanding and the unsightly split so commonly seen in women who like to wear these type of earrings.

### BACKGROUND OF THE INVENTION

1. Field of Invention

The invention relates to heavy earrings and a way of protecting the earlobe from unnecessary tear and damage from prolonged use of such heavy items.

2. Description of Related Art

One of the many versions of this device is shown in FIG. 1, the device shows how typically this device will look being discreet and comfortable to the wearer while offering protection to the earlobe.

### DRAWINGS—FIGURES

FIG. 1 shows how the device would be worn, behind the ear and barely noticeable.

FIG. 2 is a rear view of the device being worn.

FIG. 3 is a view the device.

FIG. 4 is a variation of the device; it has a ring on one end that would be attached to the upper side of the ear.

FIG. 5 is a variation of the device; it has a bar on one end that would be attached to the upper side of the ear.

FIG. 6 is a variation of the device on FIG. 4, having a small non corrosive metal chain at one end and a ring at the other.

FIG. 7 is a variation of the device on FIG. 5, having a small non corrosive metal chain at one end and a bar at the other.

FIG. 8 is a variation of the device for wearers with multiple ear piercing. It consists of an earring and a clutch with a chain extending from clutch.

FIG. 9 is a side view of FIG. 8.

FIG. 10 is a variation of FIG. 8, but the non-corrosive chain extends from the earring and not the clutch.

FIG. 11 is a side view of FIG. 10.

FIG. 12 is a variation of the device for wearers with multiple ear piercing. It consists of an earring and a clutch with a clear plastic tongue extending from the clutch.

FIG. 13 is a side view of FIG. 12.

FIG. 14 is a variation of FIG. 12, but the tongue extends from the earring and not the clutch.

FIG. 15 is a side view of FIG. 14.

### DRAWINGS—REFERENCE NUMERALS

10 Hook

11 Tongue

12 Ring

13 Bar

14 Chain

15 Earring

16 Clutch

### DETAILED DESCRIPTION OF DRAWINGS

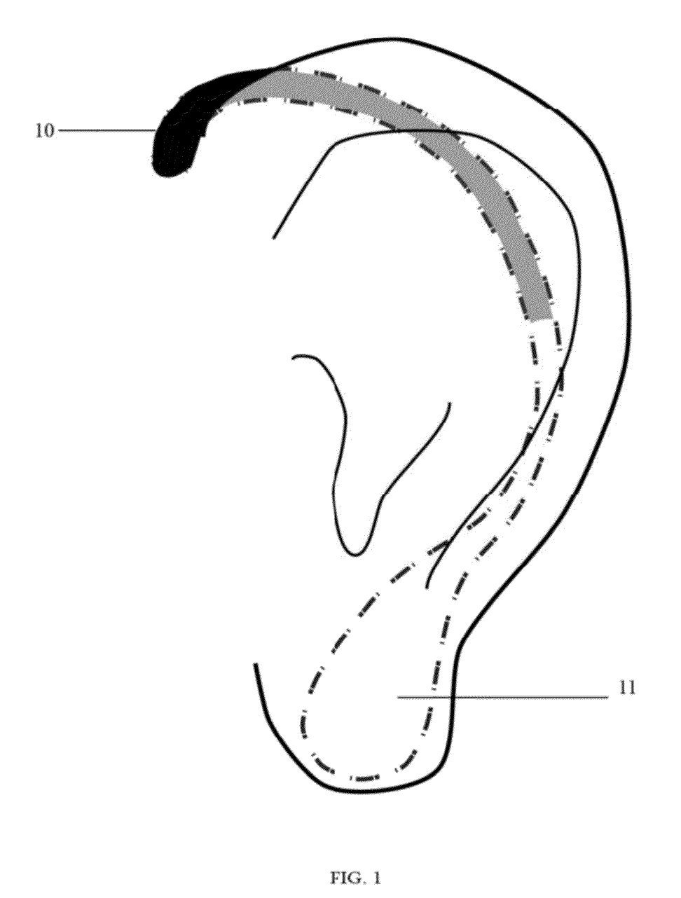

FIG. 1 shows the device as it would look if being worn. A flexible non-corrosive metal or rigid plastic (10) shaped like a hook covered by a clear flexible plastic is mounted on the upper side of the ear, and extending from it for approximately 1.5″ to 2″ inches is a clear and flexible tongue (11) which conforms to the shape of the earlobe. Such tongue (11) may or may not be pre-perforated.

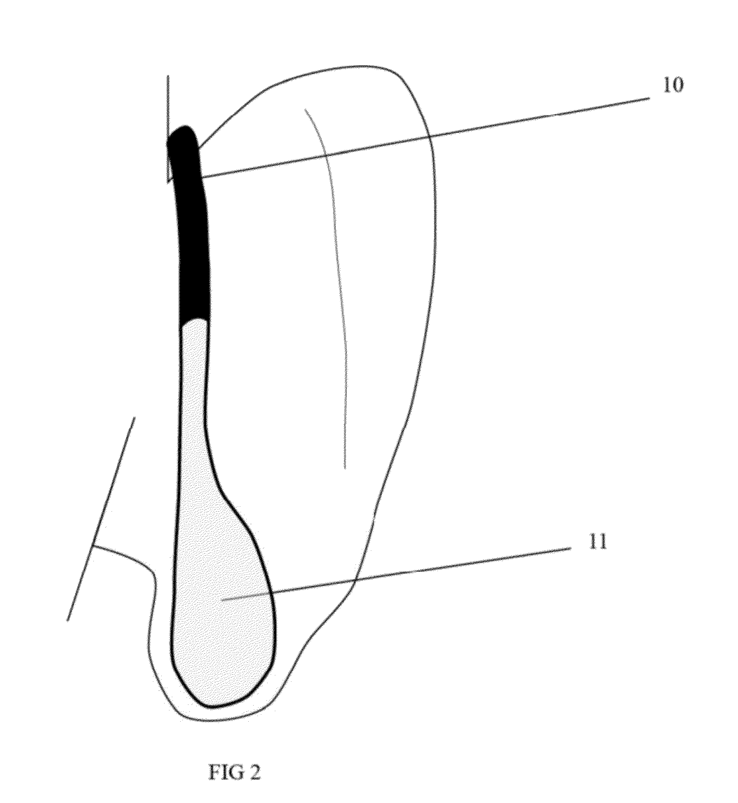

FIG. 2 shows the device as it would look from the back when being worn. A flexible non-corrosive metal or rigid plastic (10) shaped like a hook and covered by a clear flexible plastic is mounted on the upper side of the ear with a clear flexible tongue (11) extending for approximately 1.5″ to 2″ inches conforming to the shape of the earlobe. Said tongue (11) may or may not be pre-perforated.

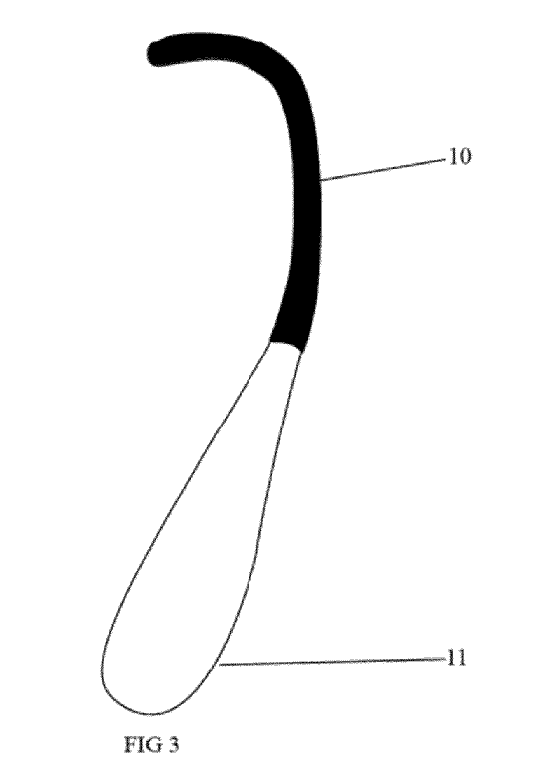

FIG. 3 shows the device by itself. A flexible non-corrosive metal or rigid plastic (10) covered by a clear and flexible plastic with a flexible clear tongue (11) extending for about 1.5″ to 2″ inches to conform to the shape of the earlobe. Said tongue (11) may or may not be pre-perforated.

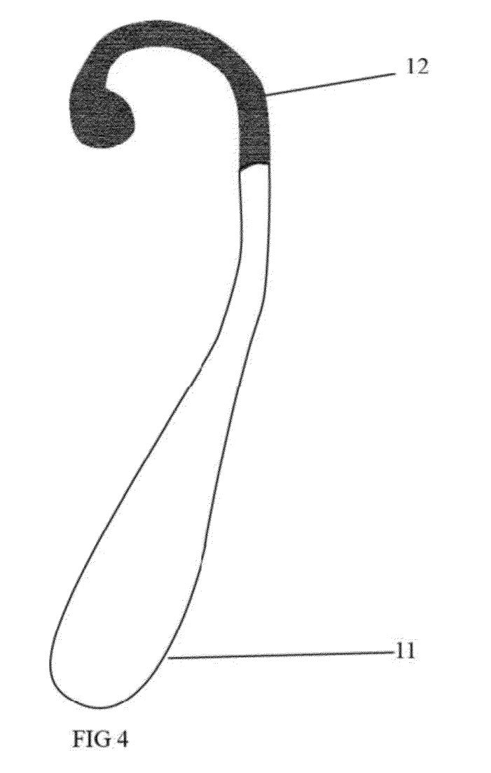

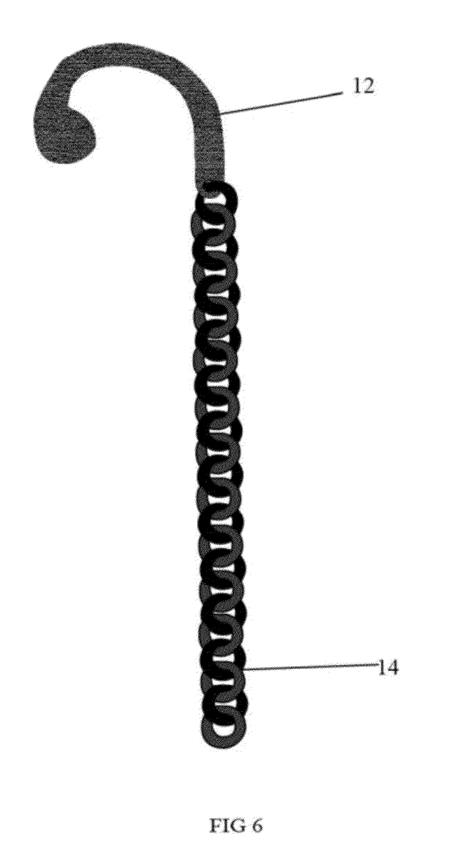

FIG. 4 and FIG. 6 consists of a ring (12) that is placed on the upper part of the ear and which is made of non-corrosive metal, precious or not, and from that ring extends clear and flexible tongue (11) which may or may not be pre-perforated; or a non-corrosive metal chain (14).

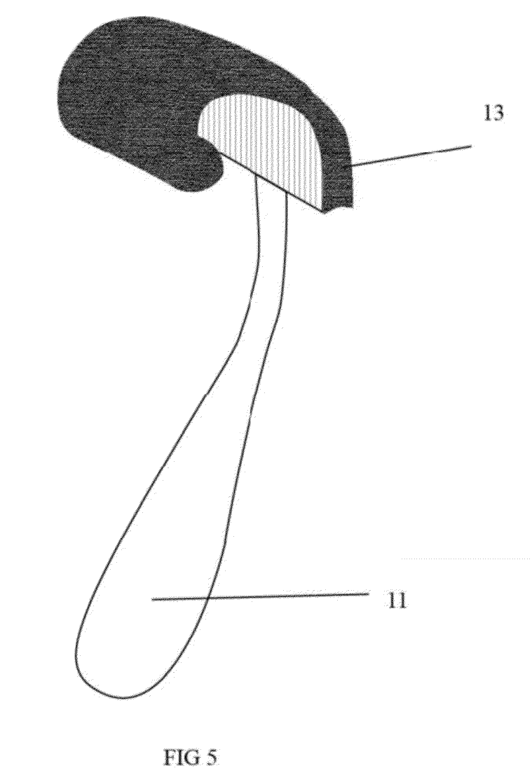

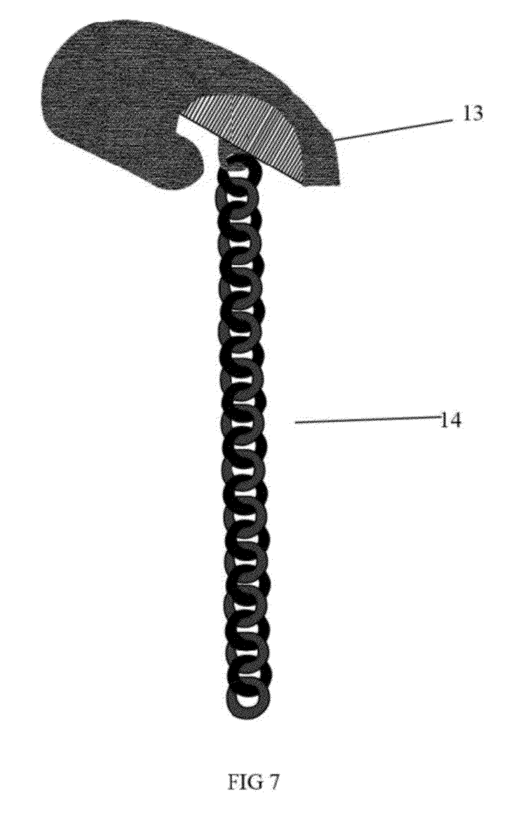

FIG. 5 and FIG. 7 consists of a non-corrosive metal bar (13) that is placed on the upper part of the ear and from which extends clear and flexible tongue (11) which may or may not be pre-perforated; or a non-corrosive metal chain (14).

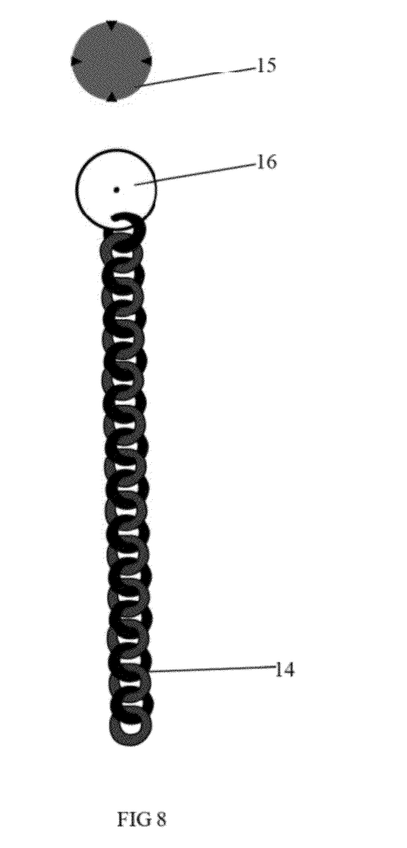

FIG. 8 consists of an earring (15) for individuals who have multiple piercing and the top of their ears are pierced, with a non-corrosive chain (14) extending from the earring clutch (16).

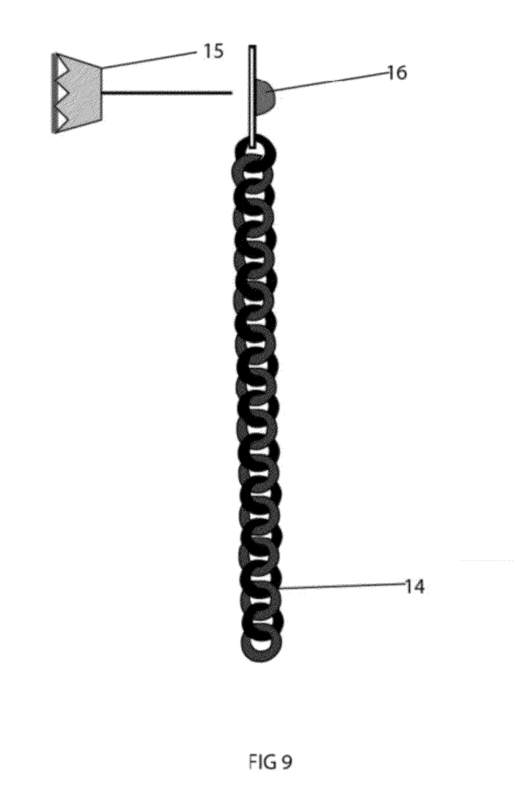

FIG. 9 is a side view of FIG. 8.

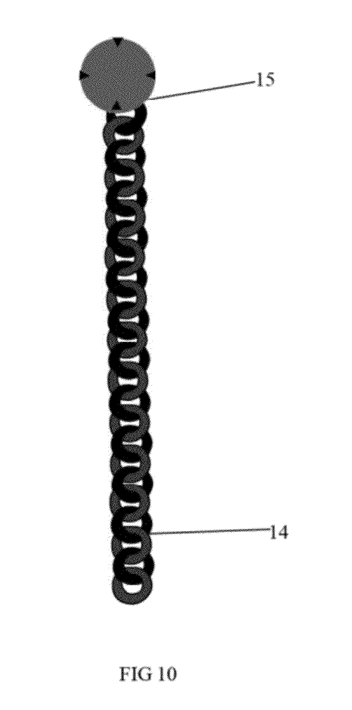

FIG. 10 consists of an earring (15) for individuals who have multiple piercing and the top of their ears are pierced, with a non-corrosive chain (14) extending from the earring (15).

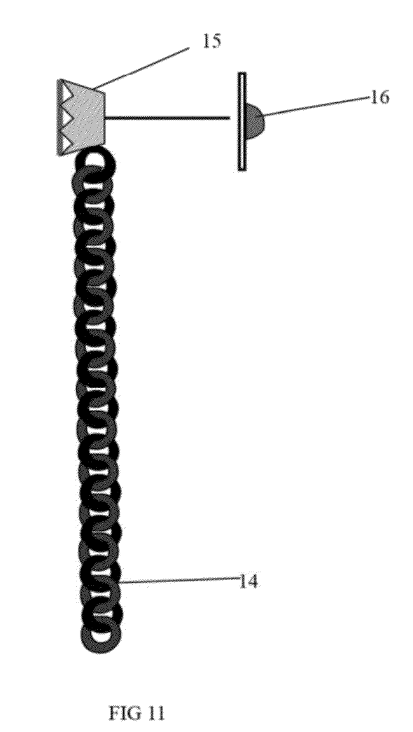

FIG. 11 is a side view of FIG. 10.

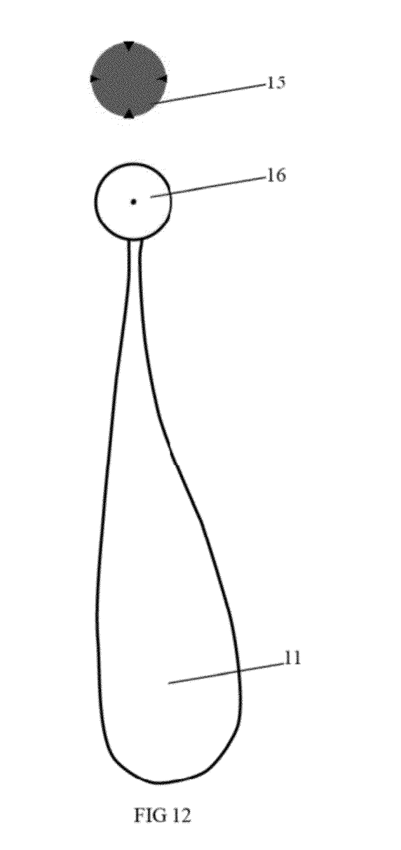

FIG. 12 consists of an earring (15) for individuals who have multiple piercing and the top of their ears are pierced, and extending from the earring clutch (16) there is a flexible clear tongue (11) which may or may not be pre-perforated.

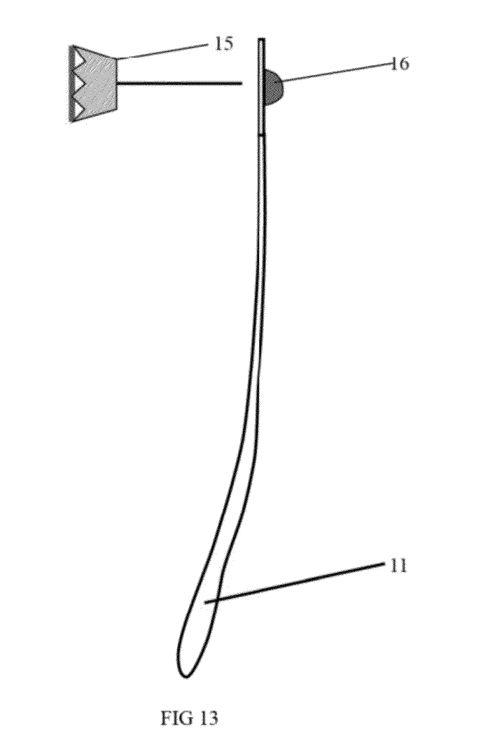

FIG. 13 is a side view of FIG. 12.

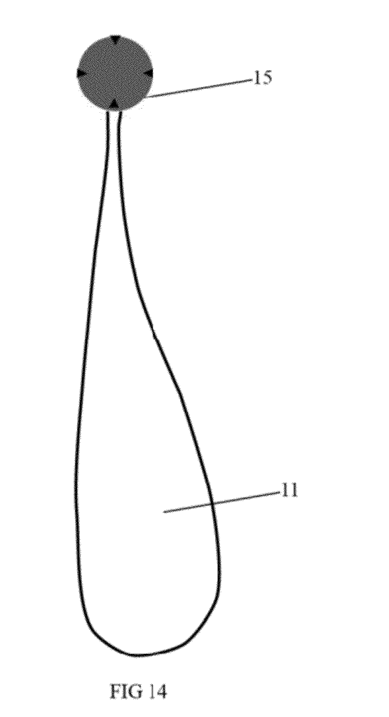

FIG. 14 consists of an earring (15) for individuals who have multiple piercing and the top of their ears are pierced, with a flexible clear tongue (11) which may or may not be perforated extending from the earring (15).

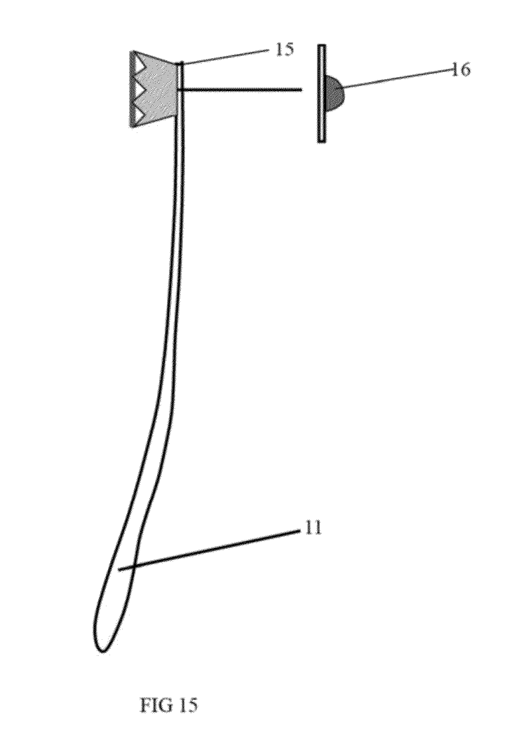

FIG. 15 is a side view of FIG. 14.

### DETAILED DESCRIPTION

### Description—Preferred Embodiment

The preferred embodiment of the present invention is illustrated in FIG. 1 and FIG. 2 (rear view) and FIG. 3. A body is formed from a segment of non-corrosive wire or rigid plastic protected by a thin layer of flexible plastic this flexible plastic could be colored or clear. The wire could be made of precious metal such as gold, platinum, silver, etc. or any non-corrosive metal or rigid plastic; typically this wire is from 2 to 4 inches in length with a clear elongated tong extending from the wire to conform to the shape of the wearer's earlobe. This tong could or could not present pre-made perforations for the wearer to hook the heavy earrings (not included) thus; this device will carry the weight of the earring whereof usually the weight would be in the earlobe therefore preventing and protecting the earlobe from expanding and the unsightly split so commonly seen in women who like to wear these type of earrings.

In the other drawings, we will see adaptations of the same invention. Some will show rings that can be placed on top of the ear, bars and even an earring for those subjects that have their ears pierced in the area, the device will have thin non-corrosive metal chain made of small links or loops, the heavy earring is inserted in the earlobe and through one of the links of the chain, the purpose and the effect is the same as the previously described, the weight of the earring will be held by the device and the top of the ear, protecting the earlobe from splitting or stretching.

### CONCLUSION, RAMIFICATIONS, AND SCOPE

Accordingly, the reader will see that the earring support device of this invention can be used to easily and conveniently relieve the stress on the wearer's earlobes caused by the weight of the earring(s). The earring support device of this invention will be inexpensive to purchase, easy to slip on and off, comfortable to wear, and easily replaced should it be lost. Furthermore, the earring support device of this invention is separate and distinct from the earring and it can be made of lightweight, flexible, material; it can be easily hidden at the wearer's discretion; it can be made from any number of lightweight, flexible materials; it provides the wearer with an extra measure of security against accidental loss; it is adjustable in length so that it may conform to the size of a particular wearer's ears; it can be adorned so as to be decorative and fashionable as well as functional; it can be used with domestic and international earring designs. Although the description above contains some specifications, these should not be construed as limiting the scope of the invention but as merely providing illustrations of some of the presently preferred embodiments of this invention.

Thus the scope of the invention should be determined by the appended claims and their legal equivalents, rather than by the examples given.

I claim:

1. A devise comprising:
a. An anti-stretching means for preventing earlobes from stretching
b. Of a bendable part at one end and an adjusting part at the other from which a reasonably heavy object can be hanged.
c. A weight distributing object that will remove reasonable weight from the earlobe and place it on the strongest portion of the ear.
